(19) United States
(12) Patent Application Publication
(10) Pub. No.: US 2021/0172852 A1
(43) Pub. Date: Jun. 10, 2021

(54) INTEGRATED THERMOPHORETIC PARTICULATE MATTER SENSORS

(71) Applicant: ams AG, Premstaetten (AT)

(72) Inventors: Anderson Singulani, Eindhoven (NL); Georg Roehrer, Eindhoven (NL)

(21) Appl. No.: 16/771,855

(22) PCT Filed: Dec. 13, 2018
(86) PCT No.: PCT/EP2018/084753

§ 371 Date: Jun. 11, 2020

Related U.S. Application Data
(60) Provisional application No. 62/599,156, filed on Dec. 15, 2017.

(51) Int. Cl. G01N 15/06; G01N 1/22

(52) U.S. Cl. CPC G01N 15/0606; G01N 2015/0046; G01N 1/2273

(57) ABSTRACT

An apparatus for sensing particulate matter in a fluid includes a first substrate; and a sensing device electrically integrated with the first substrate, the sensing device having a receiving surface. The apparatus includes a second substrate separated from the first substrate by a gap. The apparatus includes a heating element disposed in the gap between the first substrate and the second substrate and connected to the second substrate by a post. The heating element is aligned with the receiving surface of the sensing device, and a microfluidic channel is defined between the first substrate and the heating element.

### CLAIM OF PRIORITY

This application claims priority to U.S. Patent Application Ser. No. 62/599,156, filed on Dec. 15, 2017, the contents of which are incorporated herein by reference in their entirety.

This application incorporates by reference the entire contents of the following patent applications: U.S. Patent Application Ser. No. 62/599,138, filed on Dec. 15, 2017; U.S. Patent Application Ser. No. 62/599,168, filed on Dec. 15, 2017; and U.S. Patent Application Ser. No. 62/720,492, filed on Aug. 21, 2018.

### BACKGROUND

There are various types of particulate matter sensors, including sensors based on optical scattering, sensors based light absorption of filters, diffusion charging based sensors, sensors based on gravimetric filter analysis, beta attenuation sensors, tapered element oscillating microbalance sensors, and photoacoustic sensors.

### SUMMARY

In an aspect, an apparatus for sensing particulate matter in a fluid includes a first substrate; and a sensing device electrically integrated with the first substrate, the sensing device having a receiving surface. The apparatus includes a second substrate separated from the first substrate by a gap. The apparatus includes a heating element disposed in the gap between the first substrate and the second substrate and connected to the second substrate by a post. The heating element is aligned with the receiving surface of the sensing device, and a microfluidic channel is defined between the first substrate and the heating element.

Embodiment can include one or more of the following features.

The heating element includes a heater; and a support structure supporting the heater and connected to the post.

The heater includes a resistive heater formed in a dielectric membrane.

The heating element is connected to the first substrate by the support structure, the support structure defining a side wall of the microfluidic channel. The support structure is glued to the first substrate.

An area of the receiving surface of the sensing device is substantially the same size as an area of the heating element.

The heating element is configured to generate a gradient in temperature across the microfluidic channel between the heating element and the receiving surface of the sensing device.

The microfluidic channel is a first microfluidic channel, and in which the first substrate and the second substrate define first and second walls, respectively, for a second microfluidic channel fluidically connected to the first microfluidic channel.

The sensing device is formed in the first substrate.

The first substrate includes an application specific integrated circuit (ASIC).

The first substrate includes a silicon substrate.

The first substrate includes a printed circuit board, and in which the sensing device is mounted on and electrically connected to the printed circuit board.

The sensing device includes a capacitive sensor.

The sensing device includes a mass-sensitive sensor.

The sensing device includes a waveguide.

The apparatus includes multiple sensing devices integrated with the first substrate;

and multiple heating elements each aligned with a receiving surface of a corresponding one of the multiple sensing devices.

The microfluidic channel has a height of at least about 10 μm between the first substrate and the heating element.

In an aspect, a method for sensing particulate matter in a fluid includes flowing a fluid containing particulate matter through a microfluidic channel defined between a first substrate and a heating element. The heating element is disposed in a gap between the first substrate and a second substrate and connected to the second substrate by a post. The method includes operating the heating element to generate a gradient of temperature across the microfluidic channel from the heating element to a receiving surface of a sensing device electrically integrated with the first substrate.

Embodiments can include one or more of the following features.

Operating the heating element to generate a gradient of temperature causes the particulate matter in the fluid to be deposited onto the receiving surface of the sensing device.

The method includes detecting a characteristic of particulate matter deposited from the fluid onto the receiving surface of the sensing device, such as a mass of the particulate matter. The method includes detecting the characteristic of the particulate matter by capacitive sensing, mass sensing, or waveguide based sensing. The method includes characterizing an air quality of the fluid based on the detected characteristic.

In an aspect, a method for making an apparatus for sensing particulate matter in a fluid includes electrically integrating a sensing device with a first substrate, the sensing device having a receiving surface; affixing a heating element to a second substrate by a post; and attaching the second substrate to the first substrate such that the heating element is disposed in a gap between the first substrate and the second substrate and aligned with the receiving surface of the sensing device, including defining a microfluidic channel between the first substrate and the heating element.

Embodiments can include one or more of the following features.

Electrically integrating a sensing device with the first substrate includes forming the sensing device in the first substrate. Forming the sensing device in the first substrate includes forming the sensing device by complementary metal-oxide-semiconductor (CMOS) processing.

The first substrate includes a printed circuit board. Electrically integrating a sensing device with the first substrate includes mounting the sensing device on the printed circuit board and electrically connecting the sensing device to the printed circuit board.

Affixing the heating element to the first substrate includes affixing a support structure of the heating element to the first substrate, the support structure defining a side wall of the microfluidic channel. Affixing the heating element to the first substrate includes gluing the support structure to the substrate.

The method includes forming the heating element using microelectromechanical systems (MEMS) processing. Forming the heating element includes forming a heater, including forming a resistive heater in a dielectric membrane; and forming a support structure supporting the heater. Forming the heating element includes forming the heating element such that an area of the heating element is substantially the same as an area of the receiving surface of the sensing device.

In an aspect, a particulate matter sensor system for sensing particulate matter in a fluid includes an inlet microfluidic channel. The sensor system includes a particulate matter sensor including a first substrate; a sensing device electrically integrated with the first substrate, the sensing device having a receiving surface; a second substrate separated from the first substrate by a gap; and a heating element disposed in the gap between the first substrate and the second substrate and connected to the second substrate by a post. The heating element is aligned with the receiving surface of the sensing device. A sensing microfluidic channel is defined between the first substrate and the heating element and fluidically connected to the inlet microfluidic channel. The sensor system includes an outlet fluidically connected to the sensing microfluidic channel; and a fluid circulation device configured to induce gas flow from the inlet microfluidic channel, through the sensing microfluidic channel, and out the outlet.

Embodiments can include one or more of the following features.

The particulate matter sensor system includes an air quality sensing system.

The particulate matter sensors and sensor systems described here can have one or more of the following advantages. The compact size of the particle matter sensors and the size matching between heater and sensing device enables efficient capture of particulate matter, even under relatively low flow rates. More efficient capture of particulate matter can contribute to a greater accuracy in sensing results, e.g., for air quality evaluation. The particulate matter sensors and sensor systems can be fabricated using processing techniques that can be applied for efficient and inexpensive manufacture.

### BRIEF DESCRIPTION OF DRAWINGS

FIGS. 1A and 1B are diagrams of a particulate matter sensor based on thermophoretic deposition.

FIG. 2 is a diagram of a particulate matter sensor based on thermophoretic deposition.

FIGS. 3 and 4 are flow charts.

FIG. 5 is a diagram of a particulate matter sensor system.

FIG. 6 is a diagram of a mobile computing device.

### DETAILED DESCRIPTION

We describe here an integrated particulate matter sensor that includes a heater for application of a thermophoretic force onto particulate matter in a fluid. The thermophoretic force drives the particulate matter onto a sensing device, which senses the deposited particulate matter, e.g., by a capacitive or frequency-based sensing mechanism. The sensing device is electrically integrated with a substrate, such as an integrated circuit substrate or a printed circuit board substrate. The heater is also affixed to the substrate or directly to the sensing device, in alignment with the sensing device, and a microfluidic channel is defined between the heater and the sensing device for fluid flow through the particulate matter sensor. When the particulate matter sensor is incorporated into a particulate matter sensing system, an injection molded second substrate can serve as a cover layer for the system and defines a microfluidic channel for fluid flow through the particulate matter sensing system.

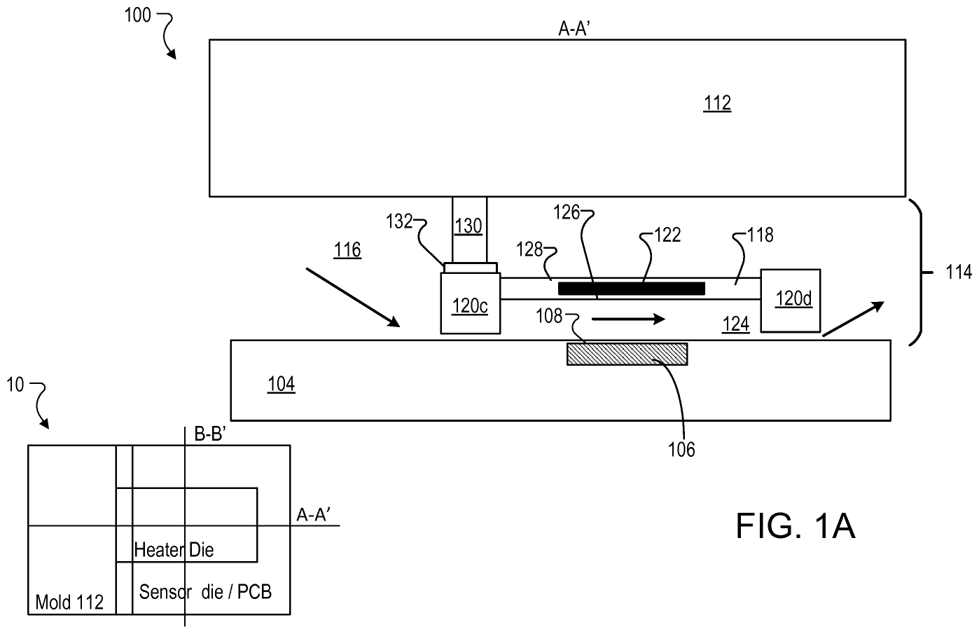

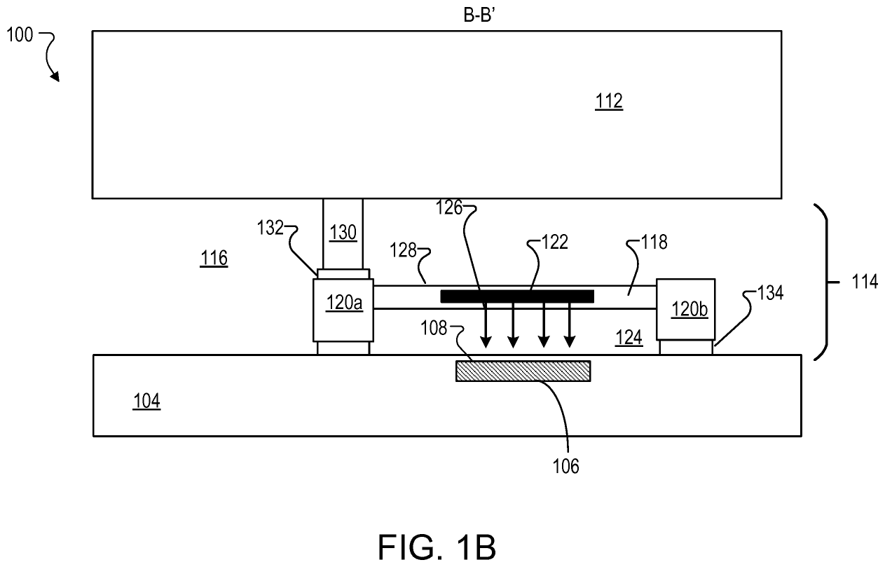

FIGS. 1A and 1B show an example particulate matter sensor 100. FIG. 1A shows a cross-sectional view of the particulate matter sensor 100 along line A-A′, seen in a top view 10 of the sensor 100. FIG. 1B shows a cross-sectional view of the particulate matter sensor along line B-B′. The particulate matter sensor 100 is a compact, integrated sensor that detects particulate matter in a fluid using a thermophoretic force to drive particulate matter onto a receiving surface of a particulate matter sensing element.

The particulate matter sensor 100 includes an integrated circuit substrate 104, such as a silicon-based integrated circuit, e.g., a complementary metal-oxide-semiconductor (CMOS) integrated circuit. A sensing device 106 is formed in and electrically integrated with the integrated circuit substrate 104. For instance, the integrated circuit 104 can be an application specific integrated circuit (ASIC) including the sensing device 106.

The sensing device 106 can be a contact interaction device that is configured to detect the presence of particulate matter on a receiving surface 108 of the sensing device. For instance, the receiving surface 108 can be a portion of the top surface of the integrated circuit substrate 104. In some examples, the sensing device 106 can be a capacitive sensing element configured to detect a change in a capacitance of the sensing device induced by the presence of particulate matter on the receiving surface. In some examples, the sensing device 106 can be a mass sensitive element, e.g., a piezoelectric based device such as a frequency bulk acoustic resonator (FBAR), that is configured to detect a change in a resonance frequency of a resonating component of the sensing device induced by the presence of particulate matter on the receiving surface 108. In some examples, the sensing device 106 can be a waveguide having a transmission characteristic that is changed when particles are deposited on the receiving surface 108, e.g., because the deposited particles modify the evanescent field of the waveguide. Other types of sensing devices can also be implemented.

A second substrate 112 is separated from the integrated circuit substrate 104 by a gap 114. A microfluidic channel 116 for fluid flow in the particulate matter sensor 100 is defined between the first substrate and the second substrate. In some examples, the second substrate 112 can form a cover layer for a particulate matter sensing system, described below. The second substrate 112 can be a molded material, e.g., an injection molded material, such as plastic.

A heating element 118, such as a hot plate, is disposed in the gap 114 between the integrated circuit substrate 104 and the second substrate 112. The heating element 118 is aligned with the receiving surface 108 of the sensing device 106. The heating element 118 includes a heater 122 including a dielectric membrane with a heating feature, such as a resistive heater, e.g., a heating coil; and a support structure 120 (shown as portions 120a-120d) surrounding the edges of the dielectric membrane holding the heater 122. The support structure 120 can provide structural stability for the dielectric membrane. For instance, the support structure 120 can be a silicon-based support structure. The support structure 120 and the heater 122 can be formed together in a microelectromechanical (MEMS) process, e.g., starting from a silicon wafer substrate.

A microfluidic channel 124 is defined between the heating element 118 and the integrated circuit substrate 104. The heater 122 of the heating element 118 produces a gradient of temperature across the microfluidic channel 124, which generates a thermophoretic force directed toward the receiving surface 108 of the sensing device 106.

When fluid, such as an aerosol (e.g., a suspension of liquid or solid particles in a gaseous medium), flows through the microfluidic channel 124, the thermophoretic force drives particulate matter in the fluid toward the receiving surface 108 of the sensing device 106. The microfluidic channel 124 can have a height of at least 10 μm or at least about 20 μm, e.g., between about 10 μm and about 150 μm, between about 10 μm and about 100 μm, between about 10 μm and about 50 μm, or between about 10 μm and about 25 μm. The small height of the microfluidic channel 124 contributes to a reasonably strong thermophoretic force being felt across the entire height of the channel 124, which can lead to more efficient capture of particulate matter from the fluid in the microfluidic channel 124 and more accurate sensing results. In addition, because the temperature gradient affects the strength of the thermophoretic force, a channel with a small height can function at a lower temperature than a larger channel, meaning that the thermophoretic deposition can be more efficient.

In some examples, the heating element 118 can be sized such that the area of the heating element 118 (including the heater 122 and the support structure 120) that faces the sensing device 106 is substantially the same as, or larger than, the area of the receiving surface 108 of the sensing device 106. For instance, the area of the heating element 118 can at least about 1% larger than the area of the receiving surface 108, e.g., at least about 2%, at least about 5%, at least about 10%, at least about 20%, or at least about 25% larger than the area of the receiving surface 108 of the sensing device 106. In a specific example, the area of the heating element 118 and the area of the receiving surface 108 of the sensing device 106 can both be between 0.5 mm² and 4 mm², e.g., between 0.5 mm² and 3 mm², between 0.5 mm² and 2 mm², or between 0.5 mm² and 1 mm². When the area of the heating element 118 is substantially the same as, or larger than, the area of the receiving surface 108, the heating element 118 is able to apply a thermophoretic force that affects the entirety of the receiving surface 108, which can lead to more efficient capture of particulate matter from the fluid in the microfluidic channel 124 and more accurate sensing results.

The heating element 118 is connected to the second substrate 112 such that both the surface 126 of the heating element 118 and an opposite surface 128 of the heating element 118 are exposed to the gap 114 between the integrated circuit substrate 104 and the second substrate 112. For instance, the heating element 118 can be connected to the second substrate 112 by a barrier post 130 that is connected to the support structure 120. The barrier post 130 can be oriented substantially orthogonal to the surface 128 of the heating element 118. In some examples, the barrier post 130 can be integral with the second substrate 112, e.g., formed of the same molding process. The barrier post 130 can be affixed to the support structure 120 by an adhesive 132, e.g., a glue. In some examples, the barrier post 130 can be integral with the support structure 120 and affixed to the second substrate 112 by an adhesive, e.g., a glue.

Two, opposite sides 120a, 120b of the support structure 120 are affixed to the integrated circuit substrate 104 by an adhesive 134, e.g., a glue. In some examples, the adhesive can be a conductive adhesive and a conductive pathway can exist through one or more of the sides 120a, 120b, e.g., such that the heater 118 can be controlled by a signal from the integrated circuit substrate 104. In some examples, the adhesive is a solder. In some examples, the adhesive can be a eutectic bond. The other two sides 120c, 120d of the support structure 120 are not affixed or otherwise connected to the integrated circuit substrate 104; rather, a gap is present between the sides 120c, 120d of the support structure 120 and the integrated circuit substrate 104.

The barrier post 130 and the support structure 120 together help to define the microfluidic channel 124. The barrier post 130 prevents fluid in the microfluidic channel 116 from flowing between the heating element 118 and the second substrate 114, instead guiding the fluid to flow through the microfluidic channel 124 between the heating element 118 and the integrated circuit substrate 104. The sides 120a, 120b of the support structure form side walls of the microfluidic channel 124, guiding the fluid to stay between the heating element 118 and the integrated circuit substrate 104. The definition of the microfluidic channel 124 as the only path for fluid through the particulate matter sensor 100 helps to ensure that all fluid flows past the sensing device 106, e.g., that all fluid is subject to the thermophoretic force that enables sensing of particulate matter in the fluid.

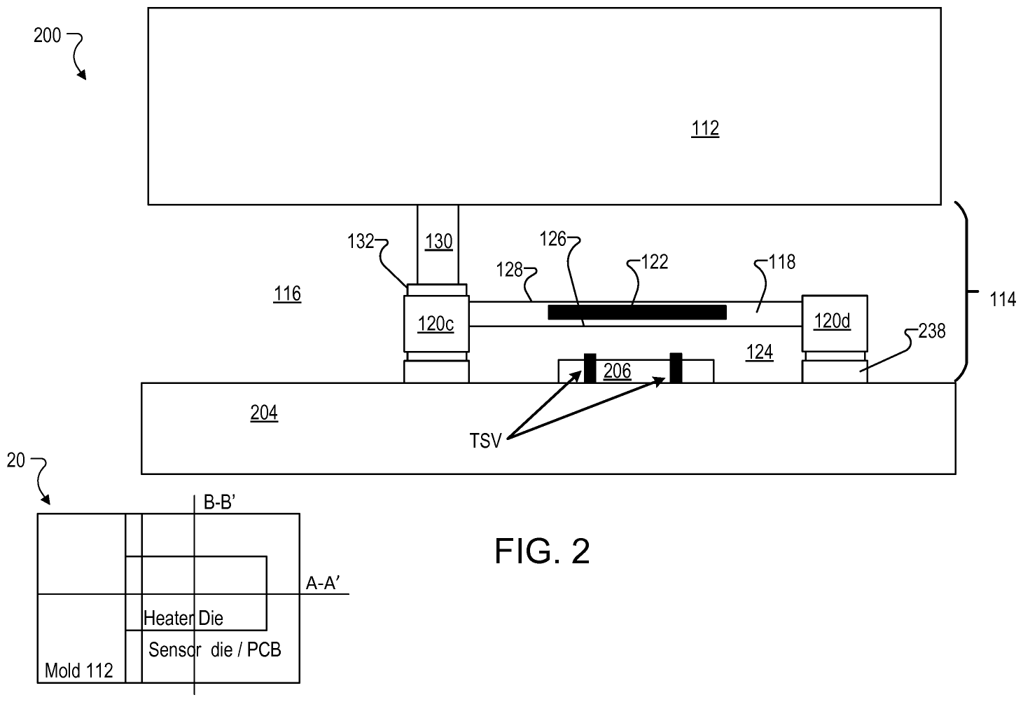

FIG. 2 shows a cross-sectional view of an example particulate matter sensor 200 along line B-B′, seen in a top view 20 of the sensor 200. The particulate matter sensor 200 includes a printed circuit board (PCB) substrate 204. A sensing device 206 is mounted on and electrically integrated with the PCB substrate 204. For instance, the sensing device 206 can be an integrated circuit, e.g., an ASIC. In some examples, the sensing device 206 can be electrically integrated with the PCB substrate 204 by through silicon vias (TSVs) 236, a backside redistribution layer, and solder balls. In some examples, the sensing device 206 can be connected to the PCB substrate 204 by wire bonding. In some examples, an underfill material can be disposed between the sensing device 206 and the PCB substrate 204, e.g., to prevent fluid from flowing between the sensing device 206 and the PCB substrate 204.

In the particulate matter sensor of FIG. 2, the sides 120a, 120b of the support structure 120 of the heating element 118 are connected to conductive elements 238 on the PCB substrate, such as copper wires. For instance, the adhesive 134 can be a conductive adhesive and a conductive pathway can exist through one or more of the sides 120a, 120b, e.g., such that the heater 118 can be controlled by a signal from the PCB substrate 204.

Some particulate matter sensors can incorporate multiple sensing device, e.g., integrated into a single integrated circuit substrate or mounted on and electrically integrated with a single PCB substrate. Each sensing device has a receiving surface, and a heater is mounted in alignment with each sensor to effect deposition of particulate matter onto the corresponding receiving surface. The incorporation of multiple sensing devices can increase the sensitivity of the particulate matter sensor, e.g., by enabling more particulate matter to be detected than in a system with only a single sensing device. The incorporation of multiple sensing devices can also prolong the lifetime of the sensor.

The configuration of the particulate matter sensors 100, 200 enable particulate sensing to be performed under low fluid flow rates, such as a fluid flow rate accessible by current micro-pump technologies, e.g., flow rates of about 1-15 mL/minute. For instance, the particulate matter sensors 100, 200 can be integrated into a particulate matter sensor system incorporating a micro-pump (discussed below). The compact size of the particulate matter sensors 100, 200 and the matching of the heater area to the area of the receiving surface of the sensing device enables efficient collection of particulate matter, even under relatively low fluid flow rates. Thermophoretic deposition is generally easier at low fluid flow rates. In addition, the ability to operate at low fluid flow rates enables the sensors to be operated with relatively small temperature gradients, with relatively small areas, or both.

The particulate matter sensors 100, 200 are assembled using die level integration schemes, also discussed below, which can decrease the cost and complexity of the assembly process. For instance, the assembly of the second substrate (e.g., the injection molded second substrate) onto the first substrate defines the microfluidic channels for fluid flow through the sensors, without the need for additional wafers or additional processing to form the microfluidic channels.

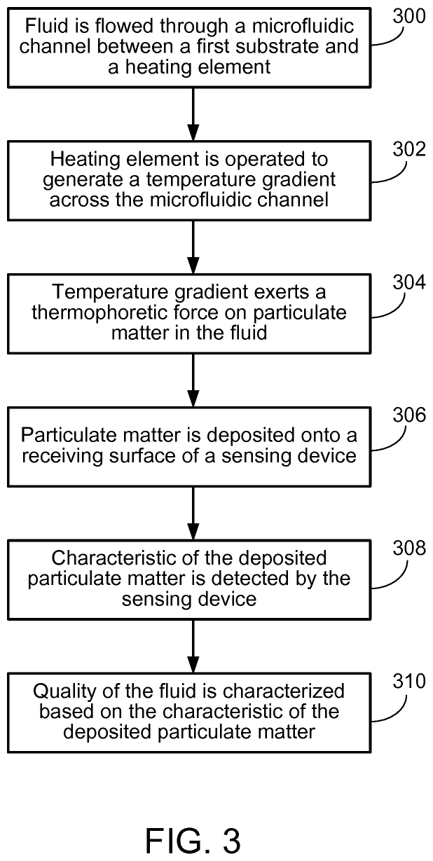

FIG. 3 shows an example approach to using a thermophoretic particulate matter sensor to sense particulate matter in a fluid. A fluid, such as air or another gas, containing particulate matter is flowed through a microfluidic channel that is defined between a first substrate and a heating element (300). For instance, fluid flow can be effected by a fluid circulation device, such as a pump, integrated onto the first substrate as part of a particulate matter sensing system, discussed below. The heating element is disposed in a gap between the first substrate (e.g., an integrated circuit substrate or a PCB substrate) and a second substrate (e.g., an injection molded substrate). The heating element is connected to the second substrate by a barrier post and to the first substrate by a support structure.

The heating element is operated to generate a temperature gradient across the microfluidic channel (302) from the heating element to a receiving surface of a sensing device that is electrically integrated with the first substrate. The temperature gradient exerts a thermophoretic force on the particulate matter in the fluid (304), causing at least some of the particulate matter to be deposited onto the receiving surface of the sensing device (306).

A characteristic of the deposited particulate matter is detected by the sensing device (308), such as a mass of the deposited particulate matter. The characteristic of the deposited particulate matter can be detected, e.g., by capacitive sensing or by FBAR sensing. A quality of the fluid (e.g., an air quality) is characterized based on the characteristic of the deposited particulate matter (310). For instance, a concentration of particulate matter in the fluid can be determined.

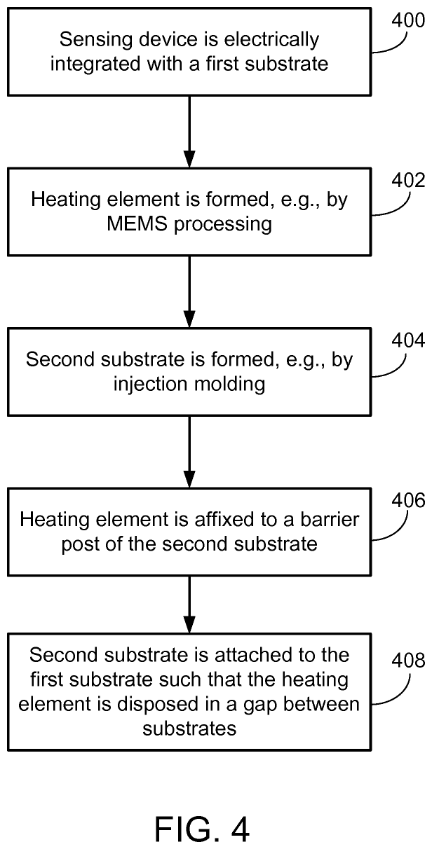

Referring to FIG. 4, in an example process for making a particulate matter sensor, a sensing device is electrically integrated with a first substrate (400). In some examples, the first substrate includes a silicon substrate, e.g., an ASIC, and electrically integrating a sensing device with the first substrate includes forming the sensing device in the first substrate, e.g., forming the ASIC using CMOS processing techniques. In some examples, the first substrate includes a PCB and electrically integrating the sensing device with the first substrate includes connecting the sensing device to the PCB by TSVs, a backside redistribution layer, and solder balls, or by wire bonding. In some examples, an underfill material can be disposed between the sensing device and the PCB.

A heating element is formed (402). For instance, the heating element can be formed in a substrate, such as a silicon substrate, using microelectromechanical systems (MEMS) processing techniques. In some examples, forming the heating element can include forming a heater, such as a dielectric membrane having a resistive heating element, such as a conductive coil; and forming a support structure for the heater, in a

MEMS fabrication process. The heating element can be formed such that an area of a surface of the heating element is substantially the same as, or slightly larger than, the area of a receiving surface of the sensing device.

A second substrate is formed (404), e.g., by a molding process, e.g., injection molding. The second substrate can be molded to include a barrier post. The heating element is affixed to the barrier post of the second substrate (406). For instance, the barrier post can be adhered, e.g., glued, to a support structure of the heating element.

The second substrate is attached to the first substrate (408) such that the heating element is disposed in a gap between the first substrate and the second substrate and aligned with the receiving surface of the sensing device. A microfluidic channel is defined between the first substrate and the heating element. The support structure of the heating element is affixed, e.g., glued, to the first substrate to define side walls of the microfluidic channel.

The incorporation of standard processing techniques, including CMOS processing, MEMS processing, and injection molding, helps to simplify production of the particulate matter sensors, and can keep production costs down.

The particulate matter sensors described here can be incorporated into microfluidic particulate matter sensor systems. The integration of the particulate matter sensors with other components of the sensor systems, such as microcontrollers and pumps, on the same substrate, enables the particulate matter sensor systems to be compact. For instance, particulate matter sensor systems incorporating the particulate matter sensors described here can have a height of less than about 3 mm, e.g., less than about 2 mm, e.g., less than about 1 mm, e.g., between about 0.75 mm and about 3 mm; and a footprint of less than about 10×10 mm².

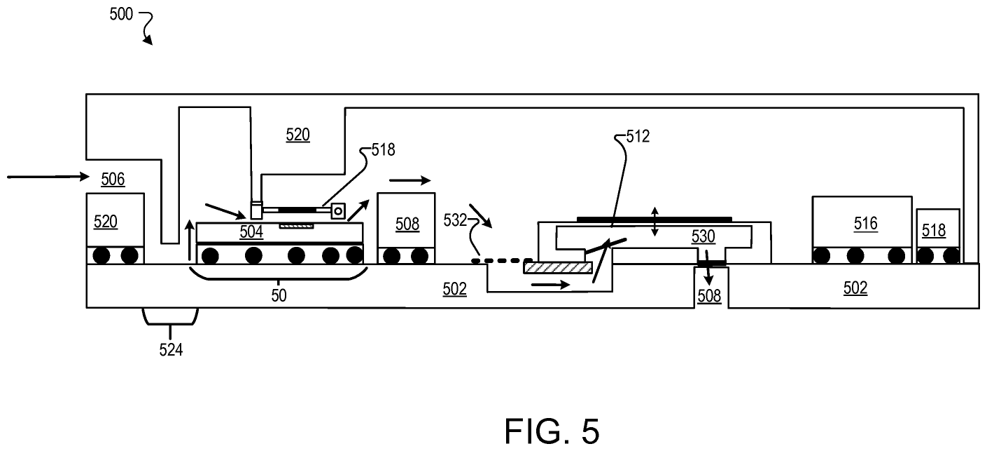

Referring to FIG. 5, a particulate matter sensor 50 such as those described above is incorporated into a particulate matter sensor system 500. A microfluidic flow path is defined through the particulate matter sensor system 500 from an inlet 506, through the particulate matter sensor 50, and out through an outlet 508.

The entire particulate matter sensor system 500, including the particulate matter sensor 50, is built on the same PCB substrate 502. When the particulate matter sensor 50 includes an integrated circuit substrate 504 (as in the particulate matter sensor 100 of FIG. 1), the integrated circuit substrate 504 is disposed on and electrically connected to the PCB substrate 502. When the particulate matter sensor includes a PCB substrate (as in the particulate matter sensor 200 of FIG. 2), the PCB substrate of the particulate matter sensor can be the same as the PCB substrate 502 of the sensor system 500. The particulate matter sensor (e.g., a heater 518 and the sensing device) is controlled by a microcontroller 510 disposed on and electrically connected to the PCB substrate 502.

A cover layer 520 is disposed over the PCB substrate 502 such that an interior space between the cover layer 520 and the PCB substrate 502 define the flow path through the sensor system 500. For instance, the cover layer 520 can be a molded piece, e.g., a molded plastic piece. The heater 518 of the particulate matter sensor 50 is connected to the cover layer 520, e.g., the cover layer 520 acts as the second substrate described with respect to FIGS. 1 and 2.

A fluid circulation device 512 is disposed on the PCB substrate 502 and drives fluid flow through the sensor system 500. The fluid circulation device can be, e.g., a pump, a fan, a heater, an ultrasonic nozzle, or another device capable of causing fluid flow through the sensor system 500. In the example of FIG. 5, the fluid circulation device 512 is a piezoelectric membrane pump. The fluid circulation device 512 is controlled by a controller 516, including one or more capacitors and inductors 518, all of which are disposed on and electrically connected to the PCB substrate 502. A filter 532 is present upstream from an inlet to a chamber 530 of the fluid circulation device 512, e.g., to help prevent particulate matter from adversely affecting the operation of the fluid circulation device 512.

The particulate matter sensor system 500 can include a heater 520 positioned at the inlet 506 of the microfluidic flow path. The heater 520, e.g., a resistive heater, can heat the fluid flowing into the sensor system 500 to reduce condensation of humidity in the fluid flowing through the system.

The particulate matter sensor system 500 can include a size separation feature 524, such as an impactor, for preventing particles above a threshold size from flowing through the rest of the microfluidic flow path. For instance, particles above a threshold size may not be of interest for air quality measurements, but could inhibit operation of the particulate matter sensor 50, e.g., by quickly covering the sensor with particulate matter, making the sensor no longer usable. Separating out these larger particles upstream of the particulate matter sensor 50 can enable a longer lifetime for the particulate matter sensor system.

In some examples, the heater 518 can function as a flow sensor to detect a mass flow rate of fluid in the sensor system 500. For instance, one or more temperature sensors can be formed in the integrated circuit 504 or in the diaphragm of the heater 518 to determine a change in temperature of the air flowing through the heater 518, and a mass flow rate of the fluid can be determined based on the temperature change.

Additional description of particulate matter sensor systems can be found in PCT Application No. [[Attorney Docket No. 45768-0011WO1/120-17]], the contents of which are incorporated here by reference in their entirety.

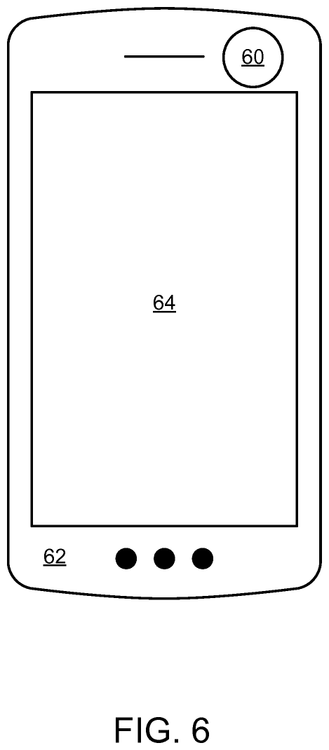

Referring to FIG. 6, a particulate matter sensor system 60 such as those described above can be incorporated into a mobile computing device 62, such as a mobile phone (as shown), a tablet, or a wearable computing device. The particulate matter sensor system 60 can be operable by a user, e.g., under control of an application executing on the mobile computing device 62, to conduct air quality testing. A test result can be displayed on a display screen 64 of the mobile computing device 62, e.g., to provide substantially immediate feedback to the user about the quality of the air in the user's environment.

The particulate matter sensor systems described here can also be incorporated into other devices, such as air purifiers or air conditioning units; or used for other applications such as automotive applications or industrial applications.

A number of embodiments have been described. Nevertheless, it will be understood that various modifications may be made without departing from the spirit and scope of the invention. For example, some of the steps described above may be order independent, and thus can be performed in an order different from that described.

Other implementations are also within the scope of the following claims.

1. An apparatus for sensing particulate matter in a fluid, the apparatus comprising:
a first substrate;
a sensing device electrically integrated with the first substrate, the sensing device having a receiving surface;
a second substrate separated from the first substrate by a gap; and
a heating element disposed in the gap between the first substrate and the second substrate and connected to the second substrate by a post, the heating element being aligned with the receiving surface of the sensing device, in which a microfluidic channel is defined between the first substrate and the heating element.

2. The apparatus of claim 1, in which the heating element comprises:
a heater; and
a support structure supporting the heater and connected to the post.

3. The apparatus of claim 1, in which the heating element comprises a resistive heater formed in a dielectric membrane.

4. The apparatus of claim 1, in which the heating element is connected to the first substrate by the support structure, the support structure defining a side wall of the microfluidic channel, optionally in which the support structure is glued to the first substrate.

5. (canceled)

6. The apparatus of claim 1, in which an area of the receiving surface of the sensing device is substantially the same size as an area of the heating element.

7. The apparatus of claim 1, in which the heating element is configured to generate a gradient in temperature across the microfluidic channel between the heating element and the receiving surface of the sensing device.

8. The apparatus of claim 1, in which the microfluidic channel is a first microfluidic channel, and in which the first substrate and the second substrate define first and second walls, respectively, for a second microfluidic channel fluidically connected to the first microfluidic channel.

9. The apparatus of claim 1, in which the sensing device is formed in the first substrate.

10. The apparatus of claim 1, in which the first substrate comprises:
an application specific integrated circuit (ASIC): and/or,
a silicon substrate

11. (Canceled)

12. The apparatus of claim 1, in which the first substrate comprises a printed circuit board, and in which the sensing device is mounted on and electrically connected to the printed circuit board.

13. The apparatus of claim 1, in which the sensing device comprises one ore more of:
a capacitive sensor;
a mass-sensitive sensor; and
a waveguide.

14. (canceled)

15. (canceled)

16. The apparatus of claim 1, comprising:
multiple sensing devices integrated with the first substrate; and
multiple heating elements each aligned with a receiving surface of a corresponding one of the multiple sensing devices.

17. (canceled)

18. A method for sensing particulate matter in a fluid, the method comprising:
flowing a fluid containing particulate matter through a microfluidic channel, the microfluidic channel being defined between a first substrate and a heating element, in which the heating element is disposed in a gap between the first substrate and a second substrate and connected to the second substrate by a post; and
operating the heating element to generate a gradient of temperature across the microfluidic channel from the heating element to a receiving surface of a sensing device electrically integrated with the first substrate.

19. The method of claim 18, in which operating the heating element to generate a gradient of temperature causes the particulate matter in the fluid to be deposited onto the receiving surface of the sensing device.

20. The method of claim 18, comprising detecting a characteristic of particulate matter deposited from the fluid onto the receiving surface of the sensing device, optionally comprising detecting a mass of the particulate matter deposited onto the receiving surface of the sensing device and/or comprising characterizing an air quality of the fluid based on the detected characteristic.

21. (canceled)

22. The method of claim 20, comprising detecting the characteristic of the particulate matter by one or more of:
capacitive sensing;
mass sensing; and
waveguide based sensing.

23-25 (canceled)

26. A method for making an apparatus for sensing particulate matter in a fluid, the method comprising:
electrically integrating a sensing device with a first substrate, the sensing device having a receiving surface;
affixing a heating element to a second substrate by a post; and
attaching the second substrate to the first substrate such that the heating element is disposed in a gap between the first substrate and the second substrate and aligned with the receiving surface of the sensing device, including defining a microfluidic channel between the first substrate and the heating element.

27. The method of claim 26, in which electrically integrating a sensing device with the first substrate comprises forming the sensing device in the first substrate, optionally comprising forming the sensing device by complementary metal-oxide-semiconductor (CMOS) processing.

28-31. (canceled)

32. The method of claim 26, comprising forming the heating element using microelectromechanical systems (MEMS) processing.

33-34. (canceled)

35. A particulate matter sensor system for sensing particulate matter in a fluid, the particulate matter sensor system comprising:
an inlet microfluidic channel;
a particulate matter sensor comprising:
a first substrate;
a sensing device electrically integrated with the first substrate, the sensing device having a receiving surface;
a second substrate separated from the first substrate by a gap; and
a heating element disposed in the gap between the first substrate and the second substrate and connected to the second substrate by a post, the heating element being aligned with the receiving surface of the sensing device, in which a sensing microfluidic channel is defined between the first substrate and the heating element and fluidically connected to the inlet microfluidic channel;
an outlet fluidically connected to the sensing microfluidic channel; and
a fluid circulation device configured to induce gas flow from the inlet microfluidic channel, through the sensing microfluidic channel, and out the outlet.

36. (canceled)
